(19) United States
(12) Patent Application Publication
(10) Pub. No.: US 2005/0058296 A1
(43) Pub. Date: Mar. 17, 2005

(54) Radio receiver

(75) Inventor: Munehiro Karasudani, Tokyo (JP)

Correspondence Address: CONNOLLY BOVE LODGE & HUTZ LLP, SUITE 800, 1990 M STREET NW, WASHINGTON, DC, 20036-3425, US

(73) Assignee: Niigata Seimitsu Co., Ltd., Jyoetsu-shi (JP)

(21) Appl. No.: 10/968,956

(22) Filed: Oct. 21, 2004

Related U.S. Application Data
(63) Continuation of application No. PCT/JP03/05262, filed on Apr. 24, 2003.

(30) Foreign Application Priority Data
Apr. 26, 2002 (JP) 2002-126989

(51) Int. Cl. H04N 5/21; H04H 5/00

(52) U.S. Cl. 381/13

(57) ABSTRACT

A radio receiver includes a noise canceller (2) for removing a pulse noise from a composite signal from an FM detection circuit (1), a stereo demodulation circuit (3) for demodulating the output signal of the noise canceller (2) to reproduce a stereo signal, and a VCO (21) for outputting a clock signal as an origin of a clock signal used in the stereo demodulation circuit (3). A clock signal used in a CCD (15) of the noise canceller (2) is generated based on a clock signal output from the VCO (21), so as to synchronize the phase of the signal used in the CCD (15) with the phase of the clock signal used in the stereo demodulation circuit (3), thereby suppressing generation of a beat signal in the output of the stereo demodulation circuit (3).

### FIELD OF THE INVENTION

The present invention relates to a radio receiver, and more particularly to a radio receiver including a function of a noise canceller for removing, by controlling the opening and closing of a gate, a pulse noise from a composite signal obtained by FM-detecting an intermediate frequency signal.

### BACKGROUND OF THE INVENTION

Generally, in an FM radio receiver, various measures against noises are taken to improve the sound quality. A typical configuration of a conventional FM radio receiver will be described below. FIG. 1 is a diagram showing an overall configuration of a conventional FM radio receiver. An FM radio receiver 100 shown in FIG. 1 includes: an antenna 101; a high frequency amplifier circuit 102; a frequency conversion circuit 103; a PLL (Phase Locked Loop) circuit 104; an intermediate frequency amplifier circuit 105; an FM detection circuit 106; a noise canceller 107; a stereo demodulation circuit 108; an audio adjustment circuit 109; a power amplifier 110; a loudspeaker 111; a divider circuit 112; a crystal oscillation circuit 113; a crystal resonator 114; a dividing circuit 115; and a voltage controlled oscillator (VCO) 116.

The high frequency amplifier circuit 102 amplifies at high frequency a broadcast signal which is input from the antenna 101, and outputs the amplified broadcast signal. The frequency conversion circuit 103 mixes the amplified broadcast signal output from the high frequency amplifier circuit 102 with an oscillation signal of a predetermined frequency which is output from the PLL circuit 104, to output an intermediate frequency signal obtained by converting the broadcast signal frequency. In a radio receiver which receives an FM broadcast signal, when a desired broadcast signal is input into the frequency conversion circuit 103, this signal is mixed with an oscillation signal of a predetermined frequency output from the PLL circuit 104 to be converted into an intermediate frequency signal of 10.7 MHz.

The PLL circuit 104 described above includes: a VCO for outputting a local oscillation signal; a divider for dividing the frequency of the local oscillation signal; a reference oscillator for outputting a reference oscillation signal; a phase comparator for comparing the phase of an output signal from the divider with that of an output signal from the reference oscillator; and a low pass filter (LPF) interposed between the phase comparator and VCO (not shown). In a radio receiver which receives high-frequency broadcast signals such as an FM broadcast signal, an LC oscillator suitable for high frequency oscillation is employed as the VCO.

The intermediate frequency amplifier circuit 105 amplifies a frequency component of a predetermined bandwidth with respect to the intermediate frequency signal output from the frequency conversion circuit 103. The FM detection circuit 106 performs a detection process with respect to the amplified intermediate frequency signal output from the intermediate frequency amplifier circuit 105 and outputs a composite signal. The noise canceller 107 removes a pulse noise from the composite signal output from the FM detection circuit 106 and outputs a signal free of the pulse noise to the stereo demodulation circuit 108.

The noise canceller 107 described above includes: a noise detection circuit for detecting the pulse noise from the composite signal output from the FM detection circuit 106; a monostable multivibrator for outputting a single pulse signal when the pulse noise is detected; a delay circuit for delaying by a predetermined period of time the composite signal output from the FM detection circuit 106; and a gate circuit which is in a cutoff state to prevent the output signal from the delay circuit from entering the stereo demodulation circuit 108 when the pulse signal is output from the monostable multivibrator.

Conventionally, as the delay circuit of the noise canceller 107, a CR type low pass filter using capacitor and resistor is commonly employed. Recently, as the low pass filter of the noise canceller 107, the use of a digital delay circuit using CCD (Condenser Coupled Device), etc. has also been proposed. When the digital delay circuit using CCD is used, a clock signal serving as the operational reference of the circuit must be supplied from the outside. This clock signal is generated by use of the divider circuit 112, crystal oscillation circuit 113 and crystal resonator 114. Specifically, an oscillation signal having a frequency dependent on the crystal resonator 114 is output from the crystal oscillation circuit 113 and then divided by the divider circuit 112, thereby creating the clock signal having a frequency required for setting an appropriate amount of delay for the CCD.

The stereo demodulation circuit 108 demodulates the composite signal free of the pulse noise which is output from the noise canceller 107, to reproduce a left channel (L) signal and a right channel (R) signal. In the stereo demodulation circuit 108, a switching operation is performed based on a clock signal of a predetermined frequency supplied from the outside, thereby converting the signal output from the noise canceller 107 into the L and R signals as a stereo signal output. The clock signal used in the above stereo demodulation circuit 108 is generated by use of a PLL circuit including the divider circuit 115 and VCO 116.

The audio adjustment circuit 109 adjusts the sound quality and volume of the L and R signals output from the stereo demodulation circuit 108. Specifically, the audio adjustment circuit 109 implements the adjustment of sound volume for the L and R signals by changing the gain of the following power amplifier 110. On the other hand, the audio adjustment circuit 109 achieves the adjustment of sound quality for the L and R signals by changing the resistance value of a built-in variable resistor (not shown) for adjusting the sound quality. The power amplifier 110 amplifies the L and R signals in accordance with the gain adjusted by the audio adjustment circuit 109. The L and R signals thus amplified are output from the loudspeaker 111.

As shown in FIG. 1 described above, when the digital delay circuit using CCD, etc. is employed as the low pass filter of the noise canceller, the frequency of the clock signal used in the CCD delay circuit is created by dividing the frequency of the signal output from the crystal oscillation circuit. On the other hand, the frequency of the clock signal used in the stereo demodulation circuit is created by dividing the frequency of the local oscillation signal output from the VCO incorporated into the PLL circuit.

More specifically, the clock frequency used in the CCD delay circuit and the clock frequency used in the stereo demodulation circuit are created separately from each other Thus there is no correlation between the two frequencies. Consequently, a problem arises that the clock signal used in the CCD delay circuit can not be synchronized with the clock signal used in the stereo demodulation circuit, thereby generating a beat signal in the output of the stereo demodulation circuit. The beat signal can cause fluctuating sound localization to thereby reduce the sound quality of the audio output. Therefore, it is desirable to suppress the generation of the beat signal.

### SUMMARY OF THE INVENTION

The present invention is devised to solve the problem described above. Accordingly, an object of the invention is to make it possible to suppress the beat signal generated by asynchronization between the clock signal used in the CCD delay circuit and the clock signal used in the stereo demodulation circuit.

A radio receiver according to the present invention includes: a noise removal circuit for removing a pulse noise from a composite signal obtained by FM-detecting an intermediate frequency signal by delaying the composite signal using a digital delay circuit, outputting the delayed composite signal to a gate and controlling the opening and closing of the gate; a stereo demodulation circuit for demodulating the composite signal free of the pulse noise which is output from the noise removal circuit, to reproduce a stereo signal; and a voltage controlled oscillator for outputting a clock signal as an origin of a clock signal having a predetermined frequency used in the stereo demodulation circuit. A clock signal having a predetermined frequency used in the digital delay circuit described above is generated according to the clock signal output from the voltage controlled oscillator described above.

According to another aspect of the invention, the radio receiver includes: a second oscillation circuit different from the voltage controlled oscillator described above; a pilot signal detection circuit for detecting a pilot signal from a composite signal output from the digital delay circuit described above; and a selection circuit for selecting as an origin of a clock signal having a predetermined frequency used in the digital delay circuit described above either of a clock signal output from the voltage controlled oscillator described above and a clock signal output from the second oscillation circuit based on a pilot detection signal output from the pilot signal detection circuit described above.

### BRIEF DESCRIPTION OF THE DRAWINGS

FIG. 1 is a diagram showing the overall configuration of a conventional FM radio receiver using CCD; and

FIG. 2 is a schematic diagram showing the configuration of an FM radio receiver according to an embodiment of the present invention.

### DETAILED DESCRIPTION OF THE PREFERRED EMBODIMENTS

An embodiment of the present invention will be described below with reference to the accompanying drawings.

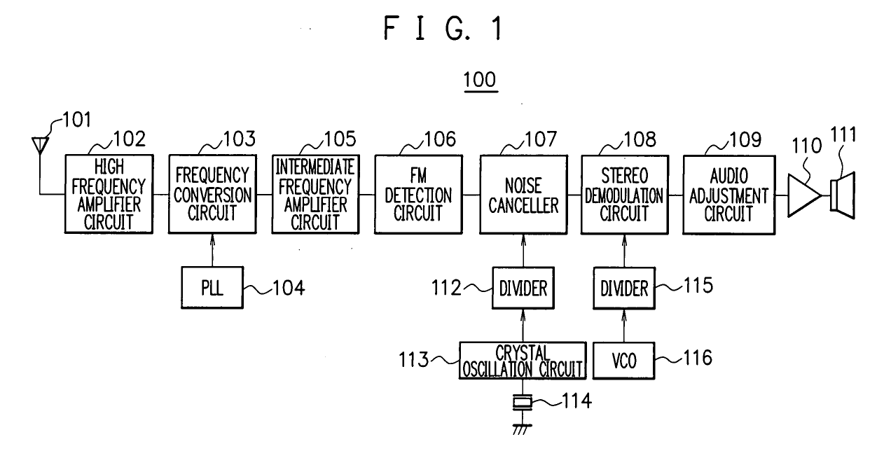

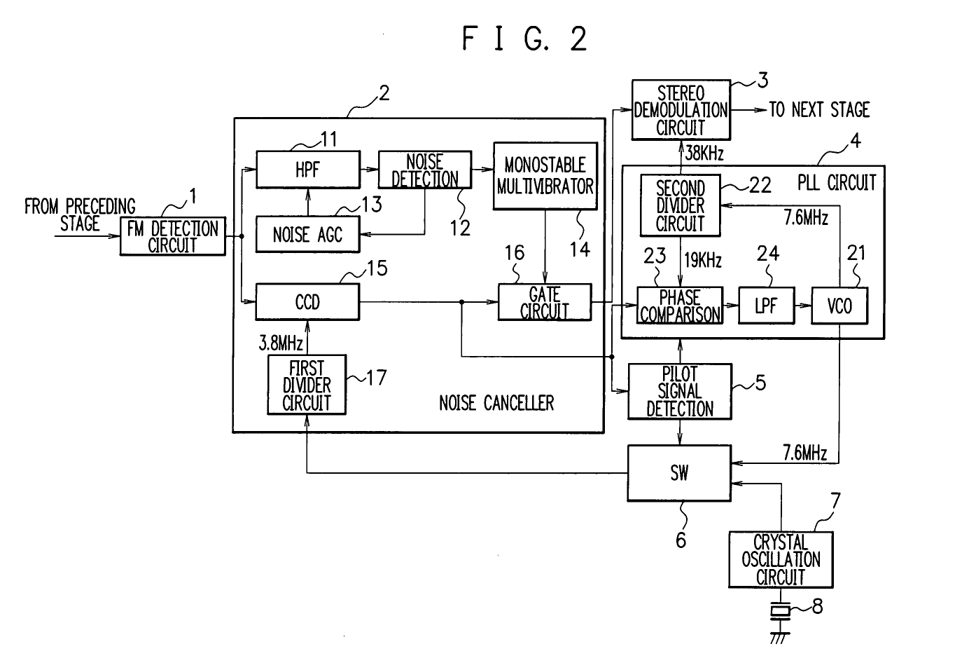

FIG. 2 is a schematic diagram showing the configuration of a main part of an FM radio receiver according to the present embodiment. Referring to FIG. 2, an FM detection circuit 1 performs a detection process with respect to an intermediate frequency signal generated from an FM broadcast signal to output a composite signal. Similarly to the circuit shown in FIG. 1, the intermediate frequency signal supplied to the FM detection circuit 1 is generated through a high frequency amplifier circuit, a frequency conversion circuit and an intermediate frequency amplifier circuit.

A noise canceller 2 removes a pulse noise from the composite signal output from the FM detection circuit 1 to output a signal free of the pulse noise to a stereo demodulation circuit 3. The noise canceller 2 includes a high pass filter (HPF) 11, a noise detection circuit 12, a noise AGC (Auto Gain Control) circuit 13, a monostable multivibrator 14, a digital delay circuit 15 such as a CCD, a gate circuit 16 and a first divider circuit 17.

The HPF 11 transmits only a high frequency component of the composite signal output from the FM detection circuit 1. The noise detection circuit 12 detects a pulse noise from the composite signal output from the HPF 11. The output signal of the noise detection circuit 12 is fed back to the HPF 11 through the noise AGC circuit 13 and supplied to the monostable multivibrator 14. When the pulse noise is detected by the noise detection circuit 12, the monostable multivibrator 14 outputs a pulse signal of a predetermined width to a control terminal of the gate circuit 16 in response to the noise detection signal.

The CCD 15 delays the composite signal output from the FM detection circuit 1 by the delay time introduced by the operation performed in the circuits extending from the HPF 11 to the gate circuit 16 and outputs the delayed composite signal to the gate circuit 16. A clock signal of a predetermined frequency (3.8 MHz for example) used in the delay operation is generated by the first divider circuit 17. The gate circuit 16 described above is normally in the ON (closed) state. On the other hand, the gate circuit 16 is in the OFF (open) state when the level of the pulse signal supplied from the monostable multivibrator 14 is “H” level, and again returns to the ON state when the level of the pulse signal returns to “L” level.

Consequently, if the pulse noise is detected from the composite signal by the noise detection circuit 12, at the timing when the composite signal containing the pulse noise is supplied through the CCD 15 to the gate circuit 16, the gate circuit 16 enters the open state, thereby preventing the composite signal containing the pulse noise from advancing from the CCD 15 to the stereo demodulation circuit 3. The stereo demodulation circuit 3 demodulates the composite signal output from the gate circuit 16 of the noise canceller 2 to reproduce an L signal and an R signal. A clock signal of a predetermined frequency (38 KHz for example) used in the stereo demodulation circuit 3 is generated by a PLL circuit 4.

The PLL circuit 4 includes a VCO 21, a second divider circuit 22, a phase comparison circuit 23 and a LPF 24. The VCO 21 generates a clock signal of a predetermined frequency (7.6 MHz for example). The second divider circuit 22 divides the frequency of the clock signal output from the VCO 21 to output the resulting signals to the stereo demodulation circuit 3 and phase comparison circuit 23. Specifically, the second divider circuit 22, including two stages of divider circuits, outputs a signal of 38 KHz to the stereo demodulation circuit 3 and a signal of 19 KHz to the phase comparison circuit 23.

The phase comparison circuit 23 compares the signal of the frequency dependent on the second divider circuit 22 with the signal (the composite signal containing the noise output from the CCD 15) of the frequency dependent on the first divider circuit 17 to determine the phase difference and outputs a signal having a duty cycle in accordance with the comparison result. The LPF 24 feeds back a control voltage corresponding to the output signal of the phase comparison circuit 23 to the VCO 21.

The pilot signal detection circuit 5 detects a pilot signal of 19 KHz from the composite signal containing the noise output from the CCD 15 and supplies the pilot signal to a PLL circuit 4 and a switch circuit 6. Based on the pilot detection signal supplied from the pilot signal detection circuit 5, the PLL circuit 4 decides whether the received broadcast signal is of stereo broadcast or of monaural broadcast to change the operational status of the second divider circuit 22 and VCO 21. Specifically, when a monaural broadcast is received, the operation of the second divider circuit 22 is terminated, thereby halting the switching operation of the stereo demodulation circuit 3. In addition, the received monaural broadcast causes the VCO 21 to enter the free running frequency operation in which the oscillator frequency of the VCO 21 is controlled by the voltage fed back from the LPF 24.

The switch circuit 6 selectively supplies to the first divider circuit 17 either of a clock signal output from the VCO 21 of the PLL circuit 4 and a clock signal output from a crystal oscillation circuit 7 which oscillates according to the frequency of a crystal resonator 8. The clock signal to be supplied is determined according to the pilot detection signal output from the pilot signal detection circuit 5. The clock signal from the VCO 21 is selected when the received broadcast signal is stereophonic; the clock signal from the crystal oscillation circuit 7 is selected when the received broadcast signal is monaural.

As described above, in the radio receiver of this embodiment, both of the clock signal used in the CCD 15 of the noise canceller 2 and the clock signal used in the stereo demodulation circuit 3 are generated by dividing the clock signal output from the same VCO 21. Thus, the phase of the clock signal used in the CCD 15 can be synchronized with the phase of the clock signal used in the stereo demodulation circuit 3, thereby suppressing generation of a beat signal in the output of the stereo demodulation circuit 3.

When a monaural broadcast is received, the VCO 21 oscillates at free running frequency, causing the frequency of the clock signal output from the VCO 21 to be unstable. The use of the clock signal having an unstable frequency for the generation of the clock signal of the CCD 15 causes the amount of delay in the CCD 15 to fluctuate, making it impossible to efficiently remove the pulse noise. According to the radio receiver of this embodiment, however, when a monaural broadcast is received, a switch is made to the clock signal of the crystal oscillation circuit 7 having a stable oscillation frequency to use this clock signal for the CCD 15, thus making it possible to effectively remove the pulse noise. In addition, since in this case there is no switching operation in the stereo demodulation circuit 3, the beat signal will not be generated.

In this embodiment, a description was given of the FM broadcast radio receiver. However, it will easily be appreciated that the invention is applicable even to an AM-FM combined radio receiver.

Furthermore, in this embodiment, an example was described in which a CCD is employed as the digital delay circuit of the noise canceller 2. However, a digital delay circuit other than this type may be utilized.

Still furthermore, in this embodiment, an example was described in which the distinction between a stereo broadcast and a monaural broadcast is achieved by the detection of the pilot signal. However, the present invention is not limited to this example.

The previous description is of a preferred example for implementing the invention, and the technical scope of the invention should not be restrictively interpreted by the description of the embodiment. Those skilled in the art will recognize that many modifications to the embodiment described above are possible without departing the spirit and gist of the invention.

As described above, according to the present invention, both of the clock signal supplied to the digital delay circuit of the noise canceller and the clock signal supplied to the stereo demodulation circuit are generated based on the clock signal output from the same voltage controlled oscillator. Thus, the phase of the clock signal used in the digital delay circuit can be synchronized with the phase of the clock signal used in the stereo demodulation circuit, thereby suppressing generation of a beat signal in the output of the stereo demodulation circuit.

According to another aspect of the invention, when a stereo broadcast is received, the clock signal of the digital delay circuit is generated based on a signal from the voltage controlled oscillator, thereby suppressing generation of a beat signal as described above. On the other hand, when a monaural broadcast is received, the clock signal of the digital delay circuit is generated not based on a signal from the unstable voltage controlled oscillator which oscillates at free running frequency in a fluctuating manner, but based on a signal from the second oscillation circuit having a stable oscillation frequency. Thus, the composite signal can be accurately delayed to effectively remove the pulse noise. In addition, since in this case there is no switching operation in the stereo demodulation circuit, the beat signal will not be generated.

Industrial Applicability

The present invention is useful for suppressing a beat signal generated by asynchronization between a clock signal used in a CCD delay circuit and a clock signal used in a stereo demodulation circuit.

1. A radio receiver, comprising:
a noise removal circuit for removing a pulse noise from a composite signal obtained by FM-detecting an intermediate frequency signal by delaying the composite signal using a digital delay circuit, outputting the delayed composite signal to a gate and controlling the opening and closing of the gate;
a stereo demodulation circuit for demodulating the composite signal free of the pulse noise which is output from the noise removal circuit, to reproduce a stereo signal; and
a voltage controlled oscillator for outputting a clock signal as an origin of a clock signal having a predetermined frequency used in the stereo demodulation circuit,
wherein a clock signal having a predetermined frequency used in the digital delay circuit is generated according to the clock signal output from the voltage controlled oscillator.

2. The radio receiver according to claim 1, comprising:
a second oscillation circuit different from the voltage controlled oscillator;
a pilot signal detection circuit for detecting a pilot signal from the composite signal output from the digital delay circuit; and
a selection circuit for selecting as an origin of the clock signal having a predetermined frequency used in the digital delay circuit either of a clock signal output from the voltage controlled oscillator and a clock signal output from the second oscillation circuit based on a pilot detection signal output from the pilot signal detection circuit.
